(19) United States
(12) Patent Application Publication
(10) Pub. No.: US 2009/0289202 A1
(43) Pub. Date: Nov. 26, 2009

(54) Integrated Encapsulation Status Indicator

(75) Inventors: Aharon Yakimov, Niskayuna, NY (US); Ahmet Gun Erlat, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/125,318

(22) Filed: May 22, 2008

(51) Int. Cl. G01N 21/00

(52) U.S. Cl. 250/473.1; 250/474.1

(57) ABSTRACT

An integrated encapsulation status indicator comprising a reactive layer that provides a visible change upon exposure to oxygen and/or moisture and an optional inert layer, wherein both layers are encapsulated with an electronic device. Also disclosed are processes for detecting oxygen and/or moisture within an encapsulated optoelectronic device.

### BACKGROUND

Organic light-emitting diodes, or OLEDs, are examples of optoelectronic devices that can have several layers of organic material and polymers. An OLED device commonly includes a substrate, an anode, a hole-transporting layer made of an organic compound, an organic luminescent layer with suitable dopants, an organic electron-transporting layer, and a cathode. OLED devices are attractive because of their low driving voltage, high luminance, wide-angle viewing and capability for full-color flat emission displays and lighting applications.

Optoelectronic devices are generally prone to degradation under ambient environment conditions. For example, a common problem with OLED devices is sensitivity to humidity. Specifically, water vapor may cause undesired crystallization and formation of organic solids within the device; undesired reactions at the electrode-organic layer interfaces; corrosion of metals and the undesired migration of ionic species; and the like. The water related degradation often manifests itself as the growth of dark spots in the active emissive areas of the OLED, which can lead to performance loss, operational instability, poor color and emission accuracies, and shortened operational life. Quantity of dark spot, their size and location are based upon the time and extent of exposure to degrading conditions.

To minimize such degradation mechanisms, organic optoelectronic devices such as organic light-emitting devices are typically encapsulated using some form of hermetic packaging, which may include the use of thin barrier films. However, even in an encapsulated environment, it is difficult to prevent all degradation, which inevitably occurs over time. To determine electronic device degradation, device status and performance are normally checked by electrical testing. However, electrical testing requires additional components, tools, and other materials. Further, such testing can use additional time, a valuable resource in a production setting.

Accordingly, there exists a need to easily identify degraded optoelectronic devices with minimal disruption and without additional testing measures.

### BRIEF SUMMARY

The present disclosure is directed to encapsulated optoelectronic devices and processes for detecting oxygen and/or moisture within the encapsulated optoelectronic device. In one embodiment, an encapsulated optoelectronic device comprises an interior region comprising a status indicator disposed therein, the status indicator comprising a reactive layer that undergoes a visible change in at least one property upon exposure to oxygen and/or moisture.

A process for detecting oxygen and/or moisture within an encapsulated optoelectronic device comprises disposing a status indicator within an interior region of the encapsulated optoelectronic device, wherein the status indicator comprises a reactive layer sensitive to the oxygen and/or moisture within the interior region, wherein the reactive layer provides an optical change upon exposure to the oxygen and/or moisture.

The disclosure may be understood more readily by reference to the following detailed description of the various features of the disclosure and the examples included therein.

### BRIEF DESCRIPTION OF THE DRAWINGS

The figures below, wherein like elements are numbered alike, are for illustrative purposes only.

FIG. 1 is an exemplary embodiment of a side view of an encapsulated electronic device with the status indicator of the present disclosure.

FIG. 2 is a top sectional view of the encapsulated optoelectronic device taken along lines 2-2 of FIG. 1.

FIG. 3 is another exemplary embodiment of a top view (a) and top view (b) of an encapsulated electronic device with the status indicator of the present disclosure.

### DETAILED DESCRIPTION

The present disclosure is generally directed to a status indicator for determining the integrity of an optoelectronic device. Specifically, this disclosure describes an encapsulation status indicator integrated in the same structure with the organic electronic device. Even more specifically, the status indicator comprises a reactive layer of an indicator material, sensitive to certain conditions that lead to degradation of an electronic device, such as oxygen or moisture. Upon reaction with the degrading condition, a visual indication of the extent of degradation can be provided. For example, the reactive layer for the visual indication may be configured to provide a response once a threshold level of contamination is detected or may be configured to provide a gradation. Advantageously, the status indicator disclosed herein does not require electrical testing or other specialized testing in order to determine the integrity of the optoelectronic device. In particular, this disclosure provides for a visual means of monitoring the device encapsulation quality, and therefore, the status of the encapsulated device itself.

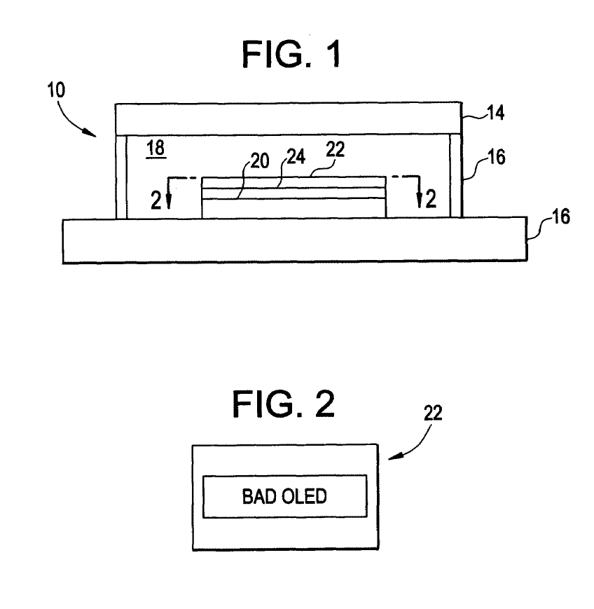

Referring now to the figures, FIGS. 1 and 2 illustrate cross sectional and top down sectional views of an encapsulated optoelectronic device generally designated by reference numeral 10. The encapsulated optoelectronic device 10 generally includes a base substrate 12 and a lid 14 coupled to the base substrate 12, typically by means of a sealant 16, e.g., a UV cured epoxy so as to form an interior region 18. An optoelectronic device 20 is shown disposed on the base substrate 12. To provide further hermeticity, a dessicant or getter material (not shown) may be disposed within the interior region 18 created upon coupling the lid 14 to the base substrate 12. The status indicator generally includes a reactive layer 22 disposed directly on the optoelectronic device or on an optional inert layer 24 intermediate the optoelectronic device 20 and the reactive layer 22. Although in this exemplary embodiment, the status indicator is placed on the optoelectronic device 14 facing away from the substrate, the indicator could be placed on the backside of the optoelectronic device, or anywhere within the interior region 18, wherein the status indicator would be easily visible to the user and would not obstruct the device operation. The relative position and placement of the indicator should be chosen so that it can be viewed through the transparent side and not to obscure the optoelectronic device itself. For example, the packaging scheme can be selected so that both sides are transparent, a transparent substrate is utilized in combination with opaque encapsulation, or an opaque substrate is utilized in combination with transparent encapsulation.

In the top down view of FIG. 2, the reactive layer forms a visual image upon detection and reaction with a degrading condition to the optoelectronic device, e.g., moisture and/or oxygen. For example, the reactive layer can be configured to display a visual indication of the degradation status within an underlying inert layer 20 that is readily visible to an end user, e.g., an inspector. By way of example, the reactive layer 22 can be an opaque layer that becomes transparent upon exposure and reaction to moisture and/or oxygen, thereby revealing a warning message 24 as shown or reveal a label or reveal color change, or reveal an optical change so as to provide visual indication of the status of the optoelectronic device. Alternatively, the reactive layer itself may form the visual image upon exposure to the degrading condition.

In another embodiment, the reactive layer is configured to become transparent upon reaction with the degrading condition to expose the underlying inert layer, which provides a visual indication of status. In this embodiment, the inert layer can include highly contrasting features to provide relatively easy visual identification, e.g., black text on a white background. Optionally, the inert layer can be configured to diffuse reflectively, e.g., may have a matte finish to contrast with a reactive layer formed of a shiny metal reflective surface, i.e., having specular reflectivity. Still further, the thickness of the reactive layer can be graded so as to provide visual gradation upon exposure to a degrading condition.

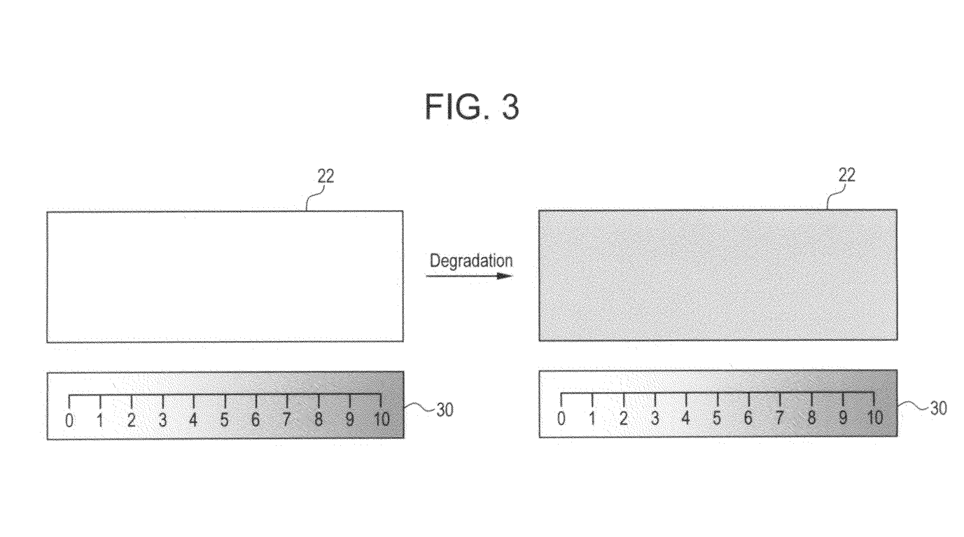

In FIG. 3, a scale 30 is positioned adjacent to the status indicator. In this manner, the end user can ascertain the magnitude of degradation based on a visual correlation of the image density provided by reaction of the degrading condition with the reactive layer 22. The scale 30 can be positioned inside or outside the interior region 18 depending on the intended application. The scale in combination with the status indicator provides quantitative data on the optoelectronic device status. For example, a fresh or non-degraded electronic device with may be configured to have a relatively shiny reactive layer 22. As the reactive layer 22 becomes exposed to moisture, oxygen, and/or other degrading conditions, a change in the optical properties of the reactive layer reveals the inert layer (not shown) underneath. The inert layer may be of a contrasting color, thereby as the color of the contrasting layer begins to show through the changing reactive layer 22, the color can be matched to an appropriate designation on the image of scale 30. In the exemplary embodiment as shown, the amount of degradation would correlate to about 5 on the scale. Accordingly, the level of degradation of the indicator could be quickly and easily identified by visual inspection.

In one embodiment, the reactive layer 22 comprises any composition that changes optical properties upon exposure to moisture, oxygen, or other degrading conditions. In an exemplary embodiment, the reactive layer comprises a metallic film, wherein the term metallic generally refers to a zero valent metal in elemental form. In a specific exemplary embodiment, a metallic film of an alkali metal can be used. Suitable metals include, without limitation, calcium or lithium or sodium, or potassium or rubidium or cesium or francium. Upon exposure to oxygen and/or moisture, the metal film forms a transparent oxide-hydroxide mixture, thereby resulting in increased light transmission and providing indication of oxygen and moisture permeation through the encapsulation. Alternatively, the indicator could indicate the status of the electronic device by other property changes of the reactive layer. For example, a color change instead of a transparency change could be used. Other suitable materials besides reactive metals could also be used, such as metal oxides. In particular, metals that form colored oxides and/or hydroxides can be used. Also, transition metals that form oxides of different colors at different oxidation states could be used. For example, VO (oxidation state +2, color black) changes color upon oxidation to VO₂ (oxidation state +4, color blue). VO₂, in turn, can change the color upon oxidation to V₂O₅ (oxidation state +5, color yellow). Alternatively, the inert layer may display matte features (diffuse reflectivity) to contrast with a shiny reactive metal surface (specular reflectivity). Other exemplary suitable materials for the reactive layer would include various dyes or inks that change color upon moisture exposure, e.g., methylene blue. Still, other suitable materials are those often used as colorimetric moisture indicators such as those disclosed in U.S. Pat. No. 6,383,815. These include, among others, cresyl-violet polymer composites, 2,4-diaminophenol dihydrochloride, manganous oxide, combination of manganous hydroxide and potassium iodide containing starch, ferrous salt in combination with methylene blue, reduced form of sodium anthraquinone-B-sulfonate, reduced form of ammonium anthraquinone-2-sulfonate, carbohydrate of Tschitschibabin, alkaline pyrogallol, and ammoniacal cuprous chloride. These and many other calorimetric reagents can be dispersed in a solid matrix, such as sol-gel, silica-gel and/or a polymer film, or dissolved in a suitable solvent.

The thickness of the reactive layer can be any suitable thickness that allows for adequate transparency and visibility of the inert layer or warning message or label of the inert layer upon exposure to moisture and/or air. Thickness could be chosen according to the predicted stability of the encapsulation used, or according to the sensitivity to degradation of the electronic device. For example, in an application where the device may tolerate exposure to oxygen and moisture for more extended periods of time without compromising function; a thicker reactive layer may be used. Similarly, where only very small amounts of degradation by moisture and/or oxygen would be tolerable to a particular device, or where encapsulation is predicted to perform for a shorter period of time, a thinner layer of reactive layer may be used. Thickness of the metal could also be graded and combined with an image of scale in the black layer, to provide quantitative data on the encapsulation status. In an exemplary embodiment, thickness of a calcium metal reactive layer is less than 100 nm.

The reactive layer can be applied by any suitable thin-film deposition process. Exemplary processes include vacuum deposition techniques such as sputter deposition, thermal or e-beam evaporation, plasma enhanced chemical vapor deposition, organic vapor phase deposition. Also wet coating or printing techniques such as ink-jet printing, screen printing, gravure coating and the like. The deposition of the reactive layer is not intended to be limited to any particular process.

The inert layer could be of any material on which the reactive layer could be applied, e.g., polymers, metals such as aluminum, tin, and the like. Like the reactive layer above, the process for forming the inert layer is not intended to be limited. The inert material is selected to be substantially inert to the ambient conditions, i.e., non-reactive to moisture and/or oxygen.

The encapsulation method can include any suitable transparent barrier for an organic electronic device. The barrier should be essentially impermeable, displaying low oxygen and water vapor transmission rates. In an exemplary embodiment, the encapsulation device is a thin film barrier coated transparent plastic substrate such as polyethylene terephthalate (PET), or transparent polyethylene naphthalate (PEN) derivatives having low oxygen and moisture permeability. Glass and metal may also be used depending on the packaging scheme. The barrier may be a color filter or transparent substrate. The barrier is attached directly to the device substrate utilizing the adhesive sealant to encapsulate the optoelectronic device. The encapsulation seal is accomplished primarily using a sealant between the bottom surface of the barrier and top surface of the device substrate. Alternatively, a very thin film barrier such as that described in U.S. Pat. No. 7,015,640 B2 can be disposed on the device surface to complete the encapsulation.

The status indicator can be used as a part of any device whose performance can degrade as a result of exposure to oxygen/moisture, and which should be encapsulated to prevent such exposure. More specifically, it can be part of any organic electronic or optoelectronic device. Even more specifically, it can be part of an organic light emitting device (OLED), utilized either as an information display or as an illumination device. Other exemplary devices include polymer light-emitting devices, charge-coupled device (CCD), micro-electro-mechanical sensors (MEMS), liquid crystal devices (LCD), electrophoretic devices, organic photovoltaic devices, thin-film transistors (TFTs) and TFT arrays using organic and solution-processible inorganic materials, photovoltaic cells, electrochromic devices and memory elements.

The substrate 12 can be any substrate used in the manufacture of an organic optoelectronic device. Materials for the substrate include, but are not intended to be limited to, an organic solid, an inorganic solid, or a combination of organic and inorganic solids that provides a surface for receiving organic material from a donor. The substrate can be rigid or flexible and can be processed as separate individual pieces, such as sheets or wafers, or as a continuous roll. Typical substrate materials include glass, plastic, metal, ceramic, semiconductor, metal oxide, semiconductor oxide, semiconductor nitride, or combinations thereof. The substrate can be a homogeneous mixture of materials, a composite of materials, or multiple layers of materials. The substrate can also be an OLED substrate, which is a substrate commonly used for preparing OLED displays, e.g. active-matrix low-temperature polysilicon TFT substrate.

This disclosure provides an advantage over current methods of monitoring device status and performance in that current methods require electrical testing in order to make integrity determinations. In conditions of mass production and extended storage, the time it takes to perform a status or performance check of encapsulation quality and integrity is very important. The advantage of the present disclosure is saving those resource costs such as the time and materials required for electrical testing. A further benefit is that the determination of device quality may be made at any point in the production or distribution chain. The ease of such a determination may lead to significant improvements or changes to existing quality control practices.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An encapsulated optoelectronic device, comprising:
an interior region comprising a status indicator disposed therein, the status indicator comprising a reactive layer that undergoes a visible change in at least one property upon exposure to oxygen and/or moisture.

2. The encapsulated optoelectronic device of claim 1, wherein the change in property is a change in optical transmission.

3. The encapsulated optoelectronic device of claim 1, wherein the change in property is a color change.

4. The encapsulated optoelectronic device of claim 1, further comprising an inert layer coupled to the reactive layer, wherein the inert layer contains a warning message or image that becomes visible upon reaction of oxygen and/or moisture with the reactive layer.

5. The encapsulated optoelectronic device of claim 4, wherein the inert layer is placed behind the reactive layer.

6. The encapsulated optoelectronic device of claim 1, further comprising an image of scale adjacent to the reactive layer, wherein the scale is configured to provide an indication of degradation level.

7. The encapsulated optoelectronic device of claim 1, wherein the reactive layer comprises a metal configured to react with the oxygen and/or the moisture.

8. The encapsulated optoelectronic device of claim 1, wherein the reactive layer is an alkali metal selected from the group consisting of calcium, lithium, sodium, potassium, rubidium, cesium, and francium.

9. The encapsulated optoelectronic device of claim 1, wherein the inert layer comprises a polymer or a metal film that is substantially inert to ambient conditions.

10. The encapsulated optoelectronic device of claim 1, wherein the electronic device is an organic light emitting diode.

11. The encapsulated optoelectronic device of claim 1, wherein the optoelectronic device comprises an organic photovoltaic device, an organic light emitting diode, a charge-coupled device, a micro-electro-mechanical sensor, a liquid crystal device, an electrophoretic device, or a thin-film organic transistor.

12. The encapsulated optoelectronic device of claim 1, wherein the reactive layer comprises a calorimetric dye configured to undergo a visible change upon exposure to oxygen and/or moisture.

13. The encapsulated optoelectronic device of claim 1, wherein the reactive layer comprises a metal oxide or metal hydroxide configured to undergo a visible change upon exposure to oxygen and/or moisture.

14. A process for detecting oxygen and/or moisture within an encapsulated optoelectronic device, the process comprising
disposing a status indicator within an interior region of the encapsulated optoelectronic device, wherein the status indicator comprises a reactive layer sensitive to the oxygen and/or moisture within the interior region; and
optically changing at least one property of the reactive layer upon exposure to the oxygen and/or moisture.

15. The process of claim 14, further comprising positioning a scale adjacent to the status indicator to provide a quantitative measurement of the optical change provided by the status indicator.

16. The process of claim 14, wherein the optically changing at least one property comprises changing a color upon reaction of the reactive layer with oxygen and/or moisture within the interior region.

17. The process of claim 14, wherein the status indicator further comprises an inert layer having contrasting features thereon coupled to the reactive layer, wherein optically changing the at least one property comprises changing optical transmission through the reactive layer to render visible the contrasting features.

18. The process of claim 14, wherein the reactive layer comprises a colorimetric dye configured to undergo the optical change upon exposure to oxygen and/or moisture.

19. The process of claim 14, wherein the reactive layer comprises a metal configured to undergo the optical change upon exposure to oxygen and/or moisture.

20. The process of claim 14, wherein the reactive layer comprises an alkali metal selected from the group consisting of calcium, lithium, sodium, potassium, rubidium, cesium, and francium.
